(19) United States
(12) Patent Application Publication
(10) Pub. No.: US 2018/0053490 A1
(43) Pub. Date: Feb. 22, 2018

(54) DISPLAY DEVICE AND METHOD OF DISPLAYING IMAGE ON DISPLAY DEVICE

(71) Applicant: SHARP KABUSHIKI KAISHA, Sakai City, Osaka (JP)

(72) Inventors: TOMOHIRO KIMURA, Sakai City (JP); MASAFUMI UENO, Sakai City (JP)

(73) Assignee: Sharp Kabushiki Kaisha

(21) Appl. No.: 15/552,797

(22) PCT Filed: Feb. 19, 2016
(86) PCT No.: PCT/JP2016/054831

§ 371 Date: Aug. 22, 2017

(30) Foreign Application Priority Data
Feb. 27, 2015 (JP) 2015-038532

(51) Int. Cl. G09G 5/38; G06K 9/00; G06F 3/0346; G06T 3/60

(52) U.S. Cl. CPC G09G 5/38; G06K 9/00255; G09G 2354/00; G06T 3/60; G09G 2340/0492; G06F 3/0346

(57) ABSTRACT

A display device 1 according to the present invention includes a display component 2 having a display surface 21 on which an image I is displayed, am image capturing component 4 configured to obtain captured image data, a control component 6 configured to detect face information about the face of a user U in the captured image data, determine an vertical direction L of the face based on the face information, generate display image data for rotating the image I to align a vertical direction M of the image I with the vertical direction L of the face, and display the image I on the display surface 21 based on the display image data.

### TECHNICAL FIELD

The present invention relates to a display device and a method of displaying an image on the display device.

### BACKGROUND ART

In these years, mobile display devices such as smartphones and tablet computers are widely used. The display device of this type includes a liquid crystal panel as a display component. For example, a circular liquid crystal panel used as a display component is described in Patent Document 1.

In such a display device, an inclination sensor, for example, for determining the gravity direction is used to find out the orientation (inclination) of the display device. The orientation of an image displayed on the display component is adjusted in accordance with the orientation of the display device (see Patent Document 1).

### RELATED ART DOCUMENT

### Patent Document

Patent Document 1: Japanese Unexamined Patent Application Publication No. 2008-281659

### Problem to be Solved by the Invention

However, the orientation of the image displayed on the display component of the display device is not sufficiently adjusted by the use of only the inclination sensor for various user orientations. For example, if the display device is horizontally positioned, the inclination sensor is not capable of detecting a change in the user orientation (for example, direction of the face), and thus the direction of the image is not changed in accordance with the user orientation.

Furthermore, the display device has a circular display component (a circular display surface) in some cases. In such cases, the display device may be used with the display surface being rotated in the circumferential direction by various angles or tilted with respect to the vertical direction by various angles. However, in the display device of this type, the orientation of the image has not been suitably adjusted to be readily viewable by the user.

### DISCLOSURE OF THE PRESENT INVENTION

An object of the invention is to provide a display device in which the orientation of a display image is adjusted in accordance with the user orientation for ease of viewing by the user.

### Means for Solving the Problem

A display device according to the invention includes a display component having a display surface on which an image is displayed, at least one image capturing component configured to obtain captured image data, and a control component configured to detect face information about a face of a user in the captured image data, determine an vertical direction of the face based on the face information, generate display image data for rotating the image align a vertical direction of the image with the vertical direction of the face, and display the image on the display surface based on the display image data.

The display device having the above-described configuration performs display control of the image in accordance with various user orientations (the vertical direction of the face) to align the vertical direction of the image with the vertical direction of the face for ease of viewing by the user.

The display device may further include an inclination sensor configured to detect an orientation angle between an inclination direction of the display surface and a gravity direction. The control component may be configured to determine a device orientation by the orientation angle, which is formed between the inclination direction and the gravity direction, and generate the display image data in accordance with a result of determination of the device orientation. The display device having such a configuration determines the device orientation and generates the display image data in accordance with the determination result of the device orientation. Thus, the contents of the display image data to be generated are changed in accordance with the device orientation.

In the display device, the control component may be configured to determine that the device orientation is horizontal when the orientation angle is relatively large and determine that the device orientation is vertical when the orientation angle is relatively small. The display device having the above-described configuration determines whether the device orientation is horizontal or vertical by the inclination angle.

In the display device, if the control component determines that the device orientation is horizontal, the control component may generate the display image data. When the device orientation is determined to be horizontal, it is preferable that the display image data be generated to perform the rotational display control of the image to align the vertical direction of the image with the vertical direction of the face.

In the display device, if the control component determines that the device orientation is vertical, the control component may calculate a face inclination angle between the gravity direction and the vertical direction of the face and generate the display image data in accordance with the face inclination angle. The display device having such a configuration generates the display image data in accordance with the face inclination angle. Thus, the contents of the display image data to be generated are changed in accordance with the face inclination angle.

In the display device, if the face inclination angle is relatively small, the control component may replace the vertical direction of the face with the vertical direction of the display surface relative to the gravity direction and generate correction display image data, instead of the display image data, for rotating the image to align the vertical direction of the image with the vertical direction of the display surface. The display device having such a configuration generates, when the face inclination angle is relatively small, the correction display image data for rotating the image to align the vertical direction of the image with the vertical direction of the display surface. In other words, when the face inclination angle is relatively small, the display control is performed to align the vertical direction of the image with the vertical direction of the display surface relative to the gravity direction. This makes the image to be readily viewable by the user.

In the display device, if the face inclination angle is relatively large, the control component may generate the display image data for rotating the image to align the vertical direction of the image with the vertical direction of the face.

In the display device, if multiple face information pieces are detected in the captured image data, the control component may select one of the multiple face information pieces closest to the display surface as the face information about the face of the user and determine the vertical direction of the face based on the selected face information piece. The display device having such a configuration selects the face information about the face of the person (the user) closest to the display surface from the multiple face information pieces.

In the display device, the at least one image capturing component may include multiple image capturing components. The image; capturing components are configured to obtain pieces of captured image data relating to the user. The control component may be configured to select one of multiple face information pieces closest to the display surface as the face information about the face of the user from the pieces of captured image data. The display device having such a configuration, in which the multiple captured image data are used, reliably selects the face information about the face of the person (the user) closest to the display surface from the multiple face information pieces.

In the display device, the display surface preferably has a circular or substantially circular shape.

In the display device, the control component may be configured to detect a trigger signal allowing the image capturing component to start capturing captured image data.

In the display device, the trigger signal may be an output from the inclination sensor.

The display device may further include an input section configured to receive information from the user and output the received information to the control component. The trigger signal may be an output from the input section.

Furthermore, a method of displaying an image according to the invention is a method of displaying an image on the display device including a display component having a display surface on which an image is displayed, am image capturing component, and a control component. The method includes obtaining captured image data by the image capturing component, detecting face information about a face of a user in the captured image data by the control component, determining an vertical direction of a face of the user by the control component based on the face information, generating a display image data for rotating the image by the control component to align the vertical direction of the image with the vertical direction of the face, and displaying the image on the display surface of the display component by the control component based on the display image data.

In the method of displaying an image on the display device, the display surface preferably has a circular or substantially circular shape.

### Advantageous Effect of the Invention

The present invention provides a display device in which an orientation of a display image is adjusted in accordance with various orientations of the user for ease of viewing by the user and a method of displaying an image on the display device.

### BRIEF DESCRIPTION OF THE DRAWINGS

FIG. 1 is a front view of a display device according to a first embodiment of the invention.

FIG. 2 is an explanatory view schematically illustrating an orientation of an image displayed on the display device when the vertical direction of a face of a user with the vertical direction of the display device.

FIG. 3 is an explanatory view schematically illustrating an orientation of the image displayed on the display device when the vertical direction of the face of the user is tilted to the left of the display device.

FIG. 4 is an explanatory view schematically illustrating an orientation of the image displayed on the display device when the vertical direction of the face of the user is tilted to the right of the display device.

FIG. 5 is an explanatory view schematically illustrating an orientation of the image displayed on the display device when the display device is turned such that the vertical direction of the display device is tilted to the right with respect to the vertical direction of the face of the user.

FIG. 6 is a block diagram indicating a configuration example of the display device according to the first embodiment.

FIG. 7 is a flowchart indicating processing steps of rotational display control according to the first embodiment.

FIG. 8 is an explanatory view schematically illustrating a method of determining a face by a detector and a method of determining the; vertical direction of the face by a facial direction detector,

FIG. 9 is an explanatory view schematically illustrating an angle between the vertical direction of the image immediately before a trigger signal is detected and the vertical direction of the face after the trigger signal is detected.

FIG. 10 is a block diagram illustrating a configuration example of a display device according to a second embodiment.

FIG. 11 is an explanatory view schematically illustrating an angle between the gravity direction and the coordinate axis of the horizontally positioned display device.

FIG. 12 is an explanatory view schematically illustrating an angle between the gravity direction and the coordinate axis of the vertically positioned display device.

FIG. 13 is an explanatory view schematically illustrating an example of an angle between the gravity direction and the vertical direction of the face of the user seen from the front.

FIG. 14 is an explanatory view schematically illustrating an example of an angle between the gravity direction and the vertical direction of the face of the user in FIG. 13 seen from left

FIG. 15 is an explanatory view schematically illustrating another example of an angle between the gravity direction and the vertical direction of the face of the user seen from the front.

FIG. 16 is a flowchart indicating processing steps of rotational display control according to a second embodiment.

FIG. 17 is an explanatory view schematically illustrating an image displayed on the display device when the face inclination angle θ3 is smaller than β.

FIG. 18 is an explanatory view schematically illustrating an image displayed on the display device when the face inclination angle θ3 is β or larger.

FIG. 19 is a front view of a display device according to a third embodiment.

FIG. 20 is a block diagram illustrating a configuration example of the display device according to the third embodiment.

FIG. 21 is a flowchart indicating processing steps of rotational display control according to the third embodiment.

FIG. 22 is an explanatory view schematically illustrating a method of determining a distance between each of two persons and the display device based on two face information pieces of the two persons.

FIG. 23 is a front view of a display device according to the third embodiment.

### MODE FOR CARRYING OUT THE INVENTION

### First Embodiment

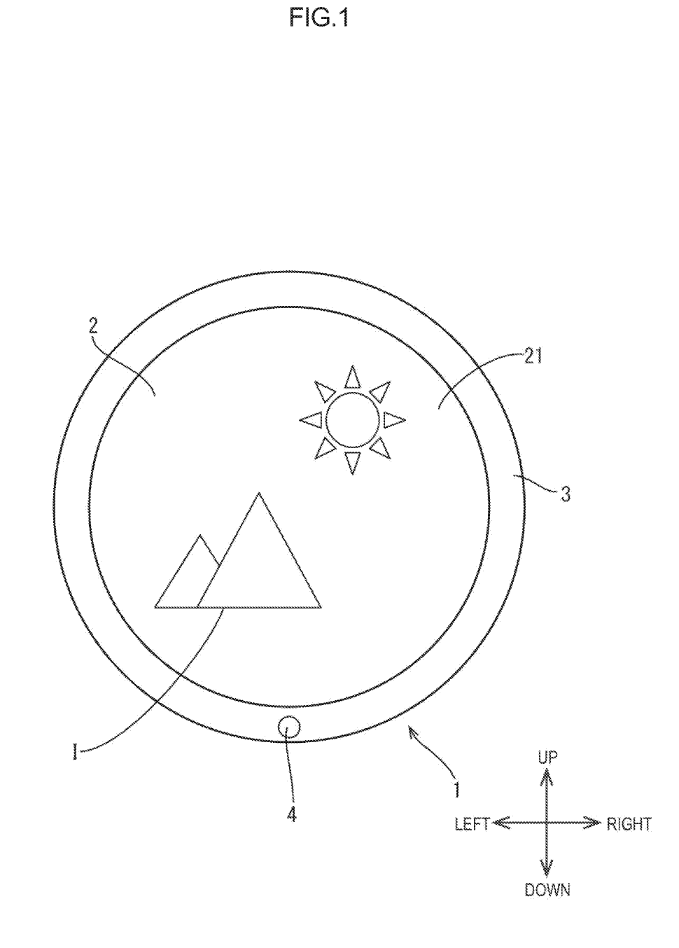

A first embodiment of the invention is described with reference to FIG. 1 to FIG. 8. In this embodiment, a mobile display device having a circular display component is described as an example.

FIG. 1 is a front view of a display device 1 according to the first embodiment of the invention. The display device 1 is a mobile display device (for example, a smart phone, or a tablet computer) and has a circular outer shape in plan view. As illustrated in FIG. 1, the display device 1 includes a circular display input section (one example of a display component) 2, which is a liquid crystal display panel having touchscreen functionality, a ring-shaped frame 3 surrounding the display input section 2, and an image capturing component 4 not covered by the frame 3.

In the display device 1, an image I, which is a still image or a moving image, is displayed on a circular display surface 21 of the display input section 2.

Herein, the side where the image capturing component 4 is located is referred to as a “lower side” of the display device 1 and the side opposite the lower side is referred to as an “upper side”. Furthermore, in the display device 1 in such a state, the right side when facing the display surface 21 is referred to as a “right side” of the display device 1 and the left side when facing the display surface 21 is a “left side” of the display device 1.

In FIG. 1, the up and down of the image I displayed on the display surface 21 with the up and down of the display device 1.

The display device 1 has a display control function of adjusting the orientation of the image I by rotating the image I to align the up and down of the image I displayed on the display surface 21 with the up and down of the user's face, without a change in the orientation of the display device 1. Herein, such display control is referred to as “rotational display control” in some cases.

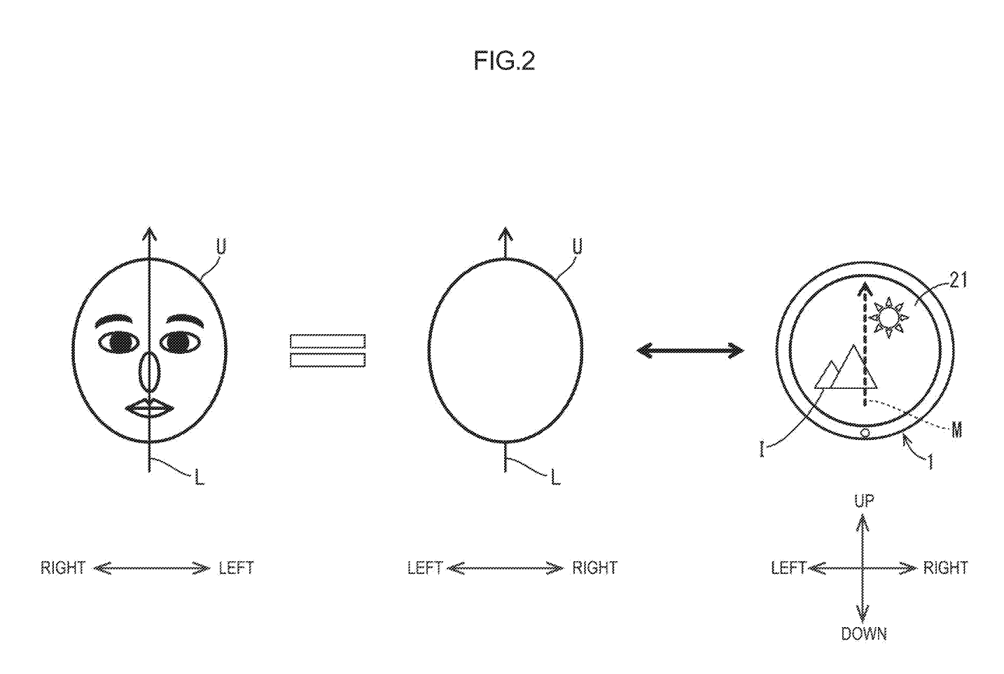

With reference to FIG. 2 to FIG. 5, the rotational display control function of the display device 1 is described. First, with reference to FIG. 2 to FIG. 4, examples in which the vertical direction L of the face of the user U is tilted to the left and the right are described.

FIG. 2 is an explanatory view schematically illustrating an orientation of the image I displayed on the display device 1 when the vertical direction L of the face of the user U matches the vertical direction of the display device 1. At the left side in FIG. 2, the face of the user U viewed from the front is illustrated. At the center in FIG. 2, the face of the user U viewed from the rear is illustrated. At the right in FIG. 2, the display device 1 viewed from the front is illustrated.

Activation of the rotational display control function of the display device 1 while the vertical direction L of the face of the user U matches the vertical direction of the display device 1 allows the image I to be displayed on the display surface 21 of the display device 1 with the vertical direction M of the image I being matched to the vertical direction L of the face.

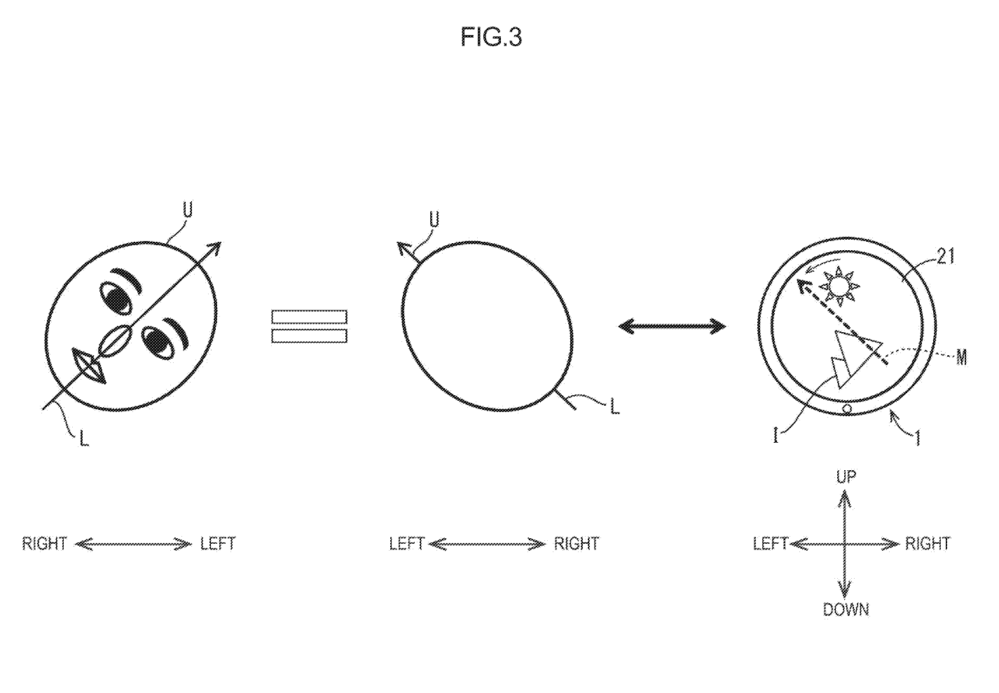

FIG. 3 is an explanatory view schematically illustrating the orientation of the image I displayed on the display device 1 when the vertical direction L of the face of the user U is tilted to the left of the display device 1. At the left side in FIG. 3, the face of the user U viewed from, the front is illustrated. At the center in FIG. 3, the face of the user U viewed from the rear is illustrated. At the right in FIG. 3, the display device 1 viewed from the front is illustrated.

For example, the vertical direction L of the face of the user U in FIG. 2 is tilted to the left of the display device 1 in some cases as illustrated in FIG. 3. In such cases, activation of the rotational display control function of the display device 1 allows the image I to turn to the left (in a counterclockwise direction) by a predetermined angle. Then, the image I is displayed on the display surface 21 of the display device 1 with the vertical direction M of the image I being matched to the vertical direction L of the face.

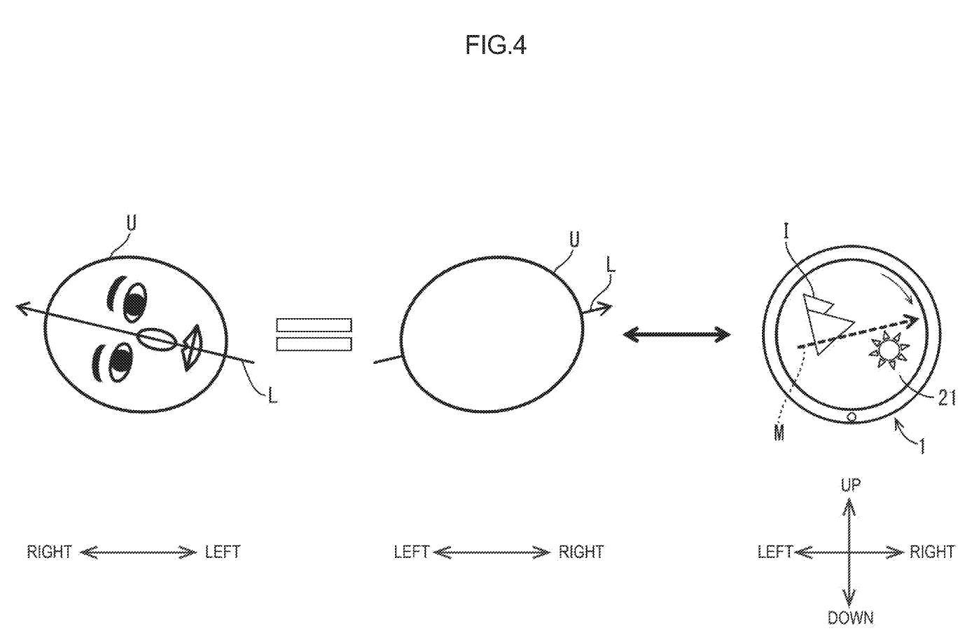

FIG. 4 is an explanatory view schematically illustrating the orientation of the image displayed on the display device 1 when the vertical direction L of the face of the user U is tilted to the right of the display device 1. At the left in FIG. 4, the face of the user U viewed from the front is illustrated. At the center in FIG. 4, the face of the user U viewed from the rear is illustrated. At the right in FIG. 4, the display device 1 viewed from the front is illustrated.

For example, the vertical direction L of the face of the user U in FIG. 2 is tilted to the right of the display device 1 in some cases as illustrated in FIG. 4. In such cases, activation of the rotational display control function of the display device 1 allows the image I to turn to the; right (in a clockwise direction) by a predetermined angle. Then, the image I is displayed on the display surface 21 of the display device 1 with the vertical direction M of the image I being matched to the vertical direction L of the face.

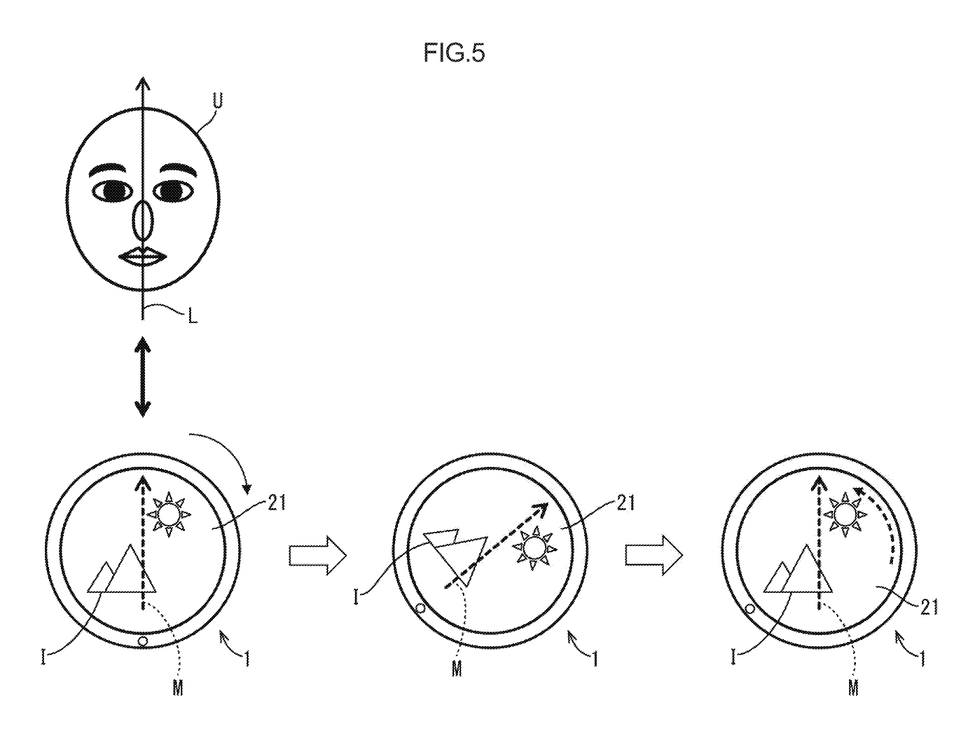

Next, an example in which the display device 1 is turned without movement of the face of the user U is described with reference to FIG. 5. FIG. 5 is an explanatory view schematically illustrating the orientation of the image I displayed on the display device 1 when the display device 1 is turned such that the vertical direction of the display device 1 is tilted to the right with respect to the vertical direction L of the face of the user U.

At the left in FIG. 5, the vertical direction L of the face of the user U matches the vertical direction of the display device 1, and the vertical direction of the display device 1 matches the vertical direction of the image I. The display device 1 in such a state is turned to the right by a predetermined angle as illustrated at the center in FIG. 5 without a change in the vertical direction L of the face of the user U. The vertical direction of the image I is tilted to the right together with the display device 1 when the rotational display control function is not activated. Then, activation of the rotational display control function allows the image I to turn to the left (in the counterclockwise direction) by a predetermined angle to align the vertical direction M of the image I with the vertical direction L of the face.

As described above, if the vertical direction L of the face of the user U changes with respect to the vertical direction M of the image I displayed on the display surface 21, the display device 1 according to this embodiment performs the display control and turns the image I to align the vertical direction M of the image 1 with the vertical direction L of the face of the user U,

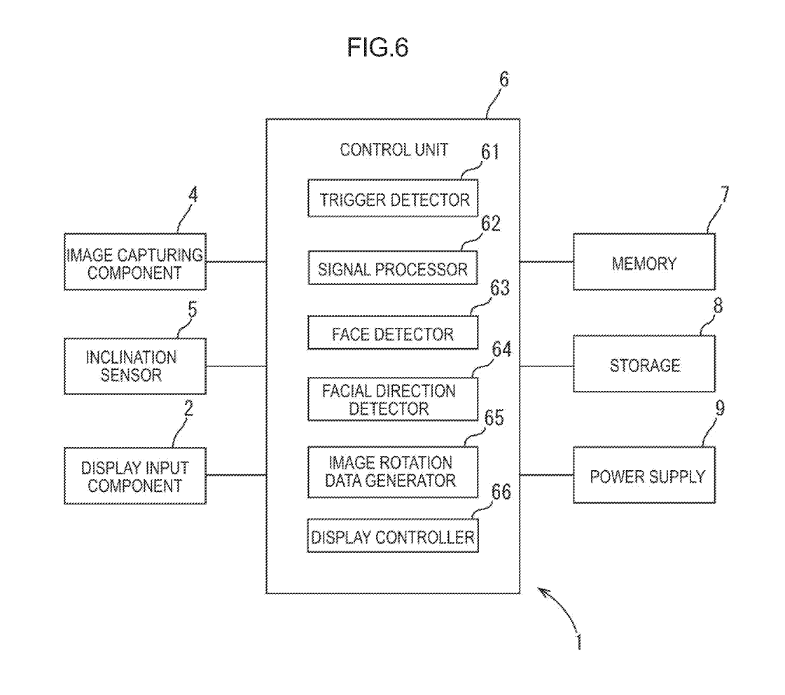

FIG. 6 is a block diagram illustrating a configuration example of the display device 1 according to the first embodiment. As illustrated in FIG. 6, the display device 1 includes an inclination sensor 5, a control component 6, a memory 7, a storage 8, and a power supply 9, as main components, in addition to the display input section 2 and the image capturing component 4.

The image capturing component 4 includes a camera, for example, and is configured to take images of am object, for example. In the image capturing component 4, an imaging device included in the camera takes images, and then electrical signals (captured image data) are generated. The electrical signals (captured image data) are input to a signal processor 62, which is described later.

The display input section (one example of the display component) 2 is a liquid crystal display panel having touch screen functionality. The display input section 2 includes an input section configured to receive various kinds of information from the user through the touchscreen and a display component configured to display the various kinds of information on the display surface 21.

The inclination sensor 5 is configured to determine the angle between the inclination direction of the display surface 21 of the displace device 1 and the gravity direction. Examples of the inclination sensor 5 include, but not limited to, an acceleration sensor.

The control component 6 is a control device such as a CPU (Central Processing Unit) configured to control components of the display device 1. The control component 6 includes a trigger detector 61, a signal processor 62, a face detector 63, a facial direction detector 64, an image rotation data generator 65, and a display controller 66.

The memory 7 includes SRAM (Static Random Access Memory) or DRAM (Dynamic Random Access Memory), for example, and is configured to temporally store various data generated during the operation of various programs executed by the control component 6.

The trigger detector 61 is configured to detect a trigger signal to start rotational display control processing (start to capture images by the image capturing component 4. The signal processor 62 is configured to convert the electrical signals from the image capturing component 4 into the image data (captured image data). The image data (captured image data) is temporally stored in the memory 7.

The face detector 63 is configured to retrieve the image data (captured image data) stored in the memory 7 and detect the face information in the image data (captured image data). The facial direction detector 64 is configured to determining the vertical direction of the face (the top and bottom of the face) based on the face information detected by the face detector 63.

The image rotation data generator 65 is configured to calculate a rotation angle of the image I by using the vertical direction L of the face determined by the facial direction detector 64 and a preset coordinate system, for example, of the display device 1 (the display surface 21) and to generate image rotation data for rotating the image I by the calculated angle.

The display controller 6 6 is configured to display the image I based on the image rotation data generated by the image rotation data generator 65, on the display surface 21 of the display input section 2.

The memory 8 includes a non-volatile recording medium such as a flash memory and an EEPROM (Electrically Erasable Programmable Read-Only Memory). The memory 8 preliminarily stores the image date of the image I to be displayed on the display surface 21 of the display input section 2, for example.

The power supply 9 includes a rechargeable battery, for example, and is configured to supply driving power to the components of the display device 1. The power supply 9 is connectable to an external power supply so as to be recharged by the external power supply as needed.

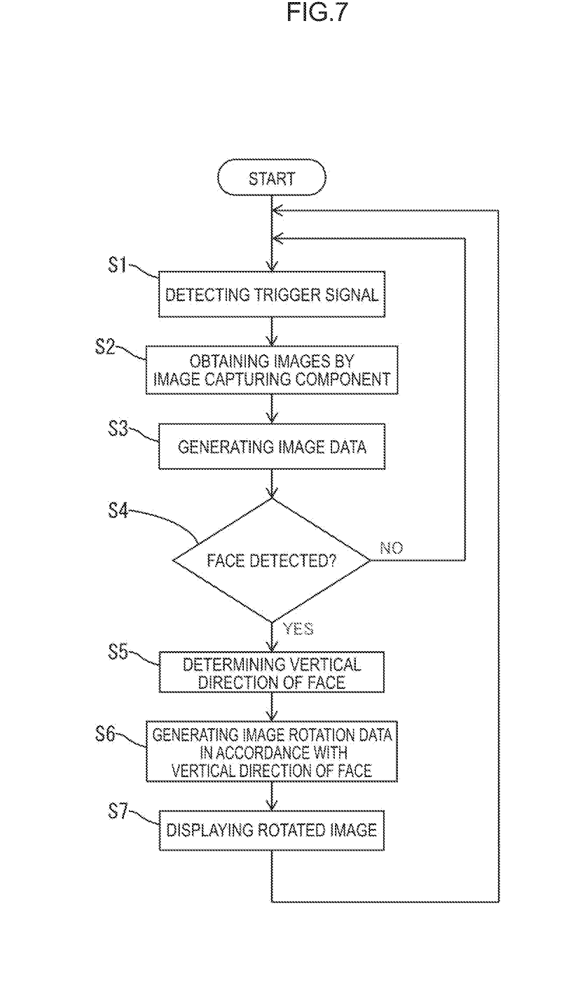

Next, the processing steps of the rotational display control according to the first embodiment of the invention is described. FIG. 7 is a flow chart indicating the processing steps of the rotational display control according to the first embodiment.

First, as indicated at step S1, in the display device 1, the trigger detector 61 detects the trigger signal to start the rotational display control processing. Examples of the trigger signal include a signal output from the display input section 2 upon receipt of information at the display input section 2, a signal output from the power supply 9 or the like upon start of recharge or upon cancellation of recharge, and a signal output from the inclination detector 5 upon activation of the inclination detector 5. The type of the trigger signal is determined as appropriate.

After the detection of the trigger signal by the trigger detector 61, the process moves to step S2 where the image capturing component 4 of the display device 1 takes images based on instructions from the control component 6. The image capturing component 4 generates electrical signals (captured image data) relating to the captured image, and the electrical signals are input to the signal processor 62. Then, the process moves to step S3.

At step S3, the signal processor 62 converts the received electrical signals into the image data (the captured image data), and the memory 7 temporally stores the image data. Then, the process moves to step S4.

At step S4, the face detector 63 retrieves the image data (the captured image data) obtained by the image capturing component 4 and detects (finds) the face of the user U in the image data. Then, after the face detector 63 has detected the face in the image data, the process moves to step S5 where the vertical direction L of the face of the user U is determined. If no face is detected by the face detector 63, the display device 1 waits until the next trigger signal is detected.

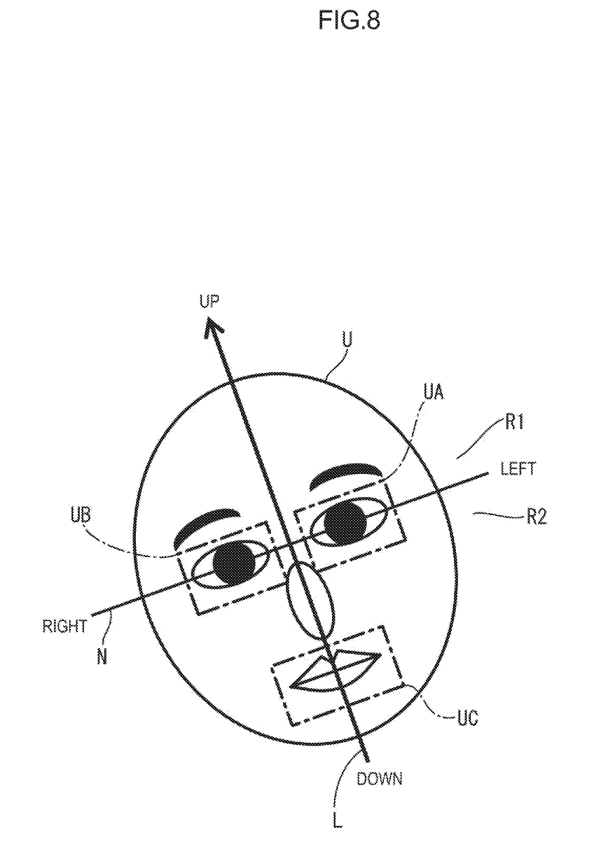

Here, with reference to FIG. 8, one example of the method of detecting a face by the face detector 63 and one example of the method of determining the vertical direction L of the face by the facial direction detector 64 are described.

FIG. 8 is an explanatory view schematically illustrating the method of detecting a face by the face detector 63 and the method of determining the vertical direction L of the face by the facial direction detector 64. The face detector 63 extracts eye information UA and UB, which relate to two eyes (both eyes) of the user U, and mouth information UC, which relate to a mouth of the user U, as reference points from the image data (captured image data) obtained by the image capturing component 4 based on a general facial recognition algorithm. The face detector 63 determines the presence or absence of a face by whether the reference points of the face such as eyes have been extracted.

If the face detector 63 detects (finds) the face of the user U, the facial direction detector 64 identifies the direction of the eyes (or the left and right direction of the face) by using a straight line N based on the extracted eye information (position information) UA and UB. A straight line perpendicular to the straight line N corresponds to the vertical direction of the face of the user U. The facial direction detector 64 determines the up and down of the face of the user U by the relationship between the mouth information (position information) UC arid the straight line N. For example, if the mouth information (position information) UC is in a region R2, which is one of regions R1 and R2 with the straight line N as the border therebetween, the region R1 is the upper side of the face and the region R2 is the lower side of the face. In this way, the vertical direction L of the face is determined as the facial information about the face of the user U based on the image data (captured image data) obtained by the image capturing component 4.

After the determination of the vertical direction L of the face, the process moves step S5 where the image rotation data generator 65 calculates the rotation angle of the image I based on the vertical direction L of the face and the preset coordinate system of the display device 1 (the display surface 21), for example, and generates image rotation data for rotating the image I by the calculated angle.

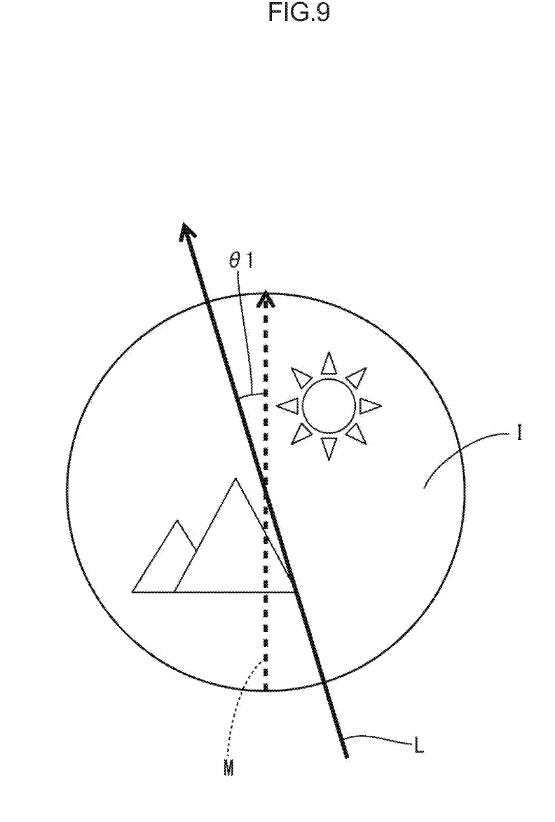

For example, the image rotation data generator 65 determines the vertical direction M of the image I immediately before the detection of the trigger signal at step S1 and calculates the angle θ1 (°) between the vertical direction M and the vertical direction L of the face (0≦θ1≦180). FIG. 9 is an explanatory view schematically illustrating the angle θ1 between the vertical direction M of the image I immediately before the detection of the trigger signal (hereinafter, referred to as a state immediately before the detection) and the vertical direction L of the face after the detection of the trigger signal. After the detection of the angle θ1, the image rotation data generator 65 generates the image rotation data for rotating the image I by the angle θ1 to align the vertical direction M of the image I with the vertical direction L of the face of the user U.

Then, the process moves to step S7 where the display controller 66 displays the image I, which is rotated by the angle 91 based on the image rotation data from the state immediately before the detection, on the display surface 21 of the display device 1.

After step S7, the display device 1 waits until the next trigger signal is detected.

As described above, the display device 1 according to this embodiment performs the display control of the image I in accordance with the above-described processing steps to align the top and bottom (the vertical direction) of the image I to be displayed on the display surface 21 with the top and bottom (the vertical direction) of the user.

### Second Embodiment

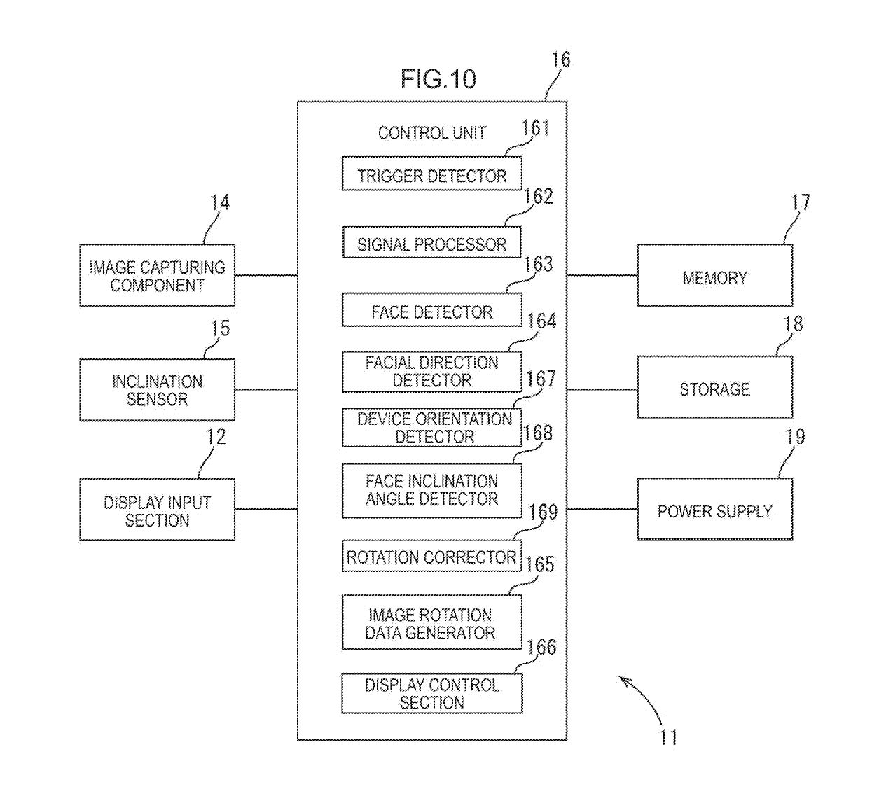

Next, a second embodiment of the invention is described with reference to FIG. 10 to FIG. 18. FIG. 10 is a block diagram indicating a configuration example of a display device 11 according to the second embodiment.

The display device 11 includes a display input section 12, an image; capturing component 14, an inclination sensor 15, a control component 16, a memory 17, a storage 18, and a power supply 19, as the first embodiment.

The control component 16 includes a trigger detector 161, a signal processor 162, a face detector 163, a facial direction detector 164, an image rotation data generator 165, and a display controller 166, as the first embodiment.

The control component 16 according to this embodiment further includes a device orientation determiner 167, a face inclination angle detector 168, and a rotation corrector 169.

The display device 11 of this embodiment changes the contents of the display control of the image I in accordance with the orientation (inclination) of the display device 11. Specifically, in one case, as the first embodiment, the display control allows the image I to be rotated to align the top and bottom of the image I, which is to be displayed on the display surface 121 of the display device 11, with the up and down of the face of the user U in accordance with the orientation (inclination) of the display device 11, and in another case, the display control allows the image I to be rotated to align the top and bottom of the image I matches the up and down of the display device 11 relative to the gravity direction.

The device orientation determiner 167 determines whether the orientation of the display device 11 is “vertical” or “horizontal” based on the angle (orientation angle) θ2 (0≦θ2 (°)≦90) between the gravity direction P and the inclination direction of the display surface 121 of the display device 11, which is the output result from the inclination sensor 15.

The inclination angle of the display surface 121 output from the inclination sensor 15 is an vertical direction Q of the display surface 121 relative to the gravity direction P. The inclination direction corresponds to a direction along a straight line connecting the highest position of the display surface 121 to the lowest position of the display surface 121.

The device orientation determiner 167 temporally stores the vertical direction Q of the display surface 121 relative to the gravity direction P in the memory 17.

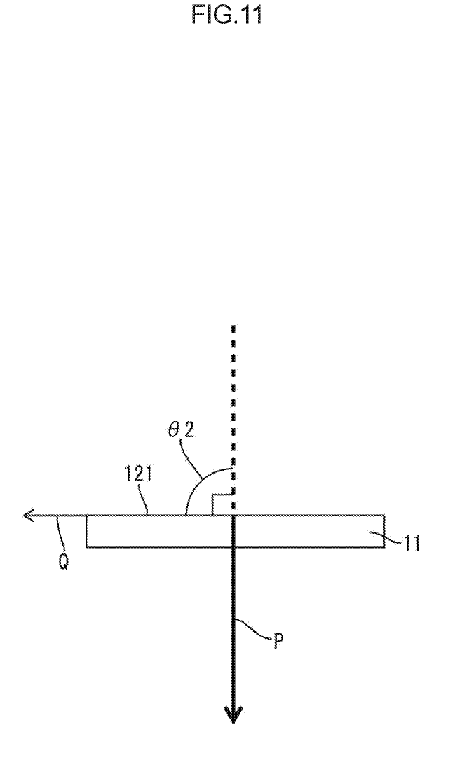

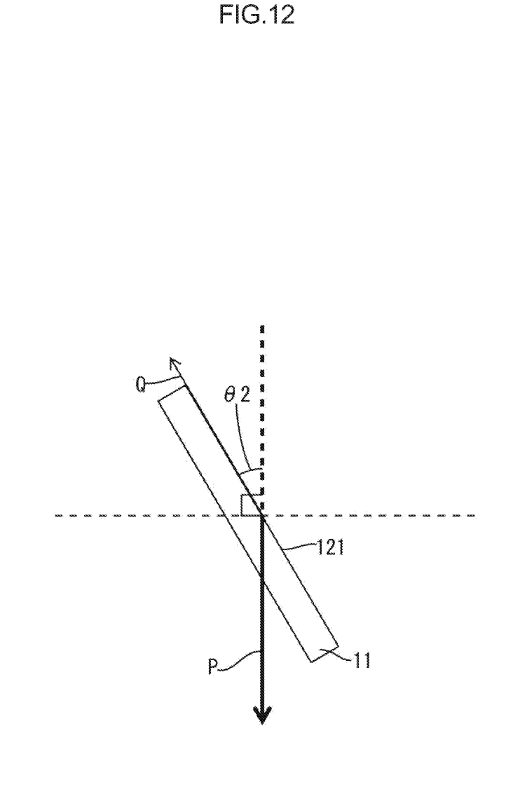

Here, with reference to FIG. 11 and FIG. 12, relationships between the angle θ2, which is formed between the gravity direction P and the display surface 121 of the display device 11, and each of “vertical” and “horizontal” orientations of the display device 11 are described.

FIG. 11 is an explanatory view schematically indicating the angle θ2 between the gravity direction P and the display surface 121 of the horizontally positioned display device 11. For example, as illustrated in FIG. 11, the display surface 121 of the display device 11 positioned on a horizontal table is horizontally positioned. The ideal angle θ2 between the display surface 121 and the gravity direction P is 90°.

In the horizontally positioned display device 11, the circular display surface 121 may be viewed from different angles by the user U. In this embodiment, the device orientation determiner 167 determines that the orientation of the display device 11 is “horizontal” if 90−α≦θ2 (°) (for example, α=0° to 10°) is satisfied.

If the device orientation determiner 167 determines that the orientation of the display device 11 is “horizontal”, the display device 11 performs the display control in which the orientation of the image I is adjusted by rotating the image I to align the top and bottom of the image I displayed on the display surface 121 matches the top and bottom of the face of the user as the first embodiment.

FIG. 12 is an explanatory view schematically indicating the angle θ2 between the gravity direction P and the display surface 121 of the vertically positioned display device

11. For example, if the user U uses the display device 11 while holding it in the hand, the display surface 121 is tilted relative to the gravity direction P by some degree as illustrated in FIG. 12, but the display device 11 as a whole stands in an upright position with respect to the horizontal direction. In this embodiment, the device orientation determiner 167 determines that the orientation of the display device 11 is “vertical” if 0≦θ2 (°)<90−α (for example, α=0° to 10°) is satisfied,

If the device orientation determiner 167 determines that the orientation is “vertical”, the face inclination angle detector 168 determines the inclination angle (face inclination angle) of the vertical direction L of the face of the user U with respect to the gravity direction P.

The face inclination angle detector 168 determines the angle (a face inclination angle) θ3 (0≦θ3 (°)≦90) between the vertical direction L of the face of the user U determined by the facial direction detector 164 and the angle of the gravity direction P obtained by the inclination sensor 15 and determines whether the angle θ3 exceeds β or not (for example, β=45°).

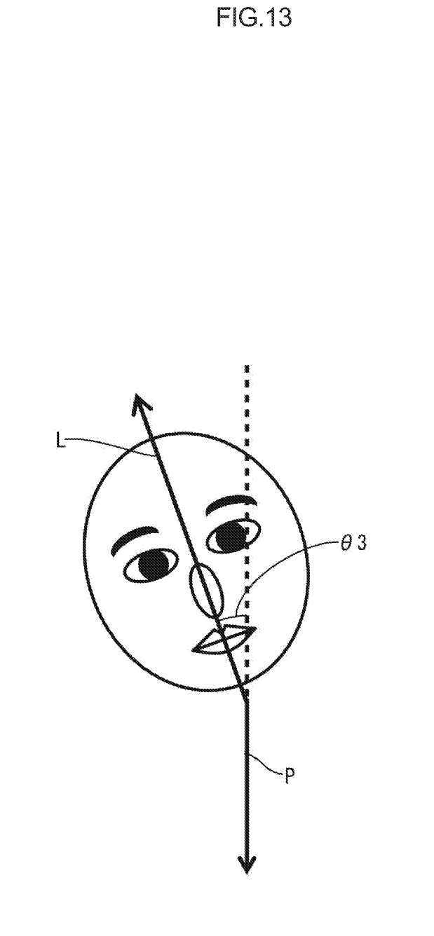

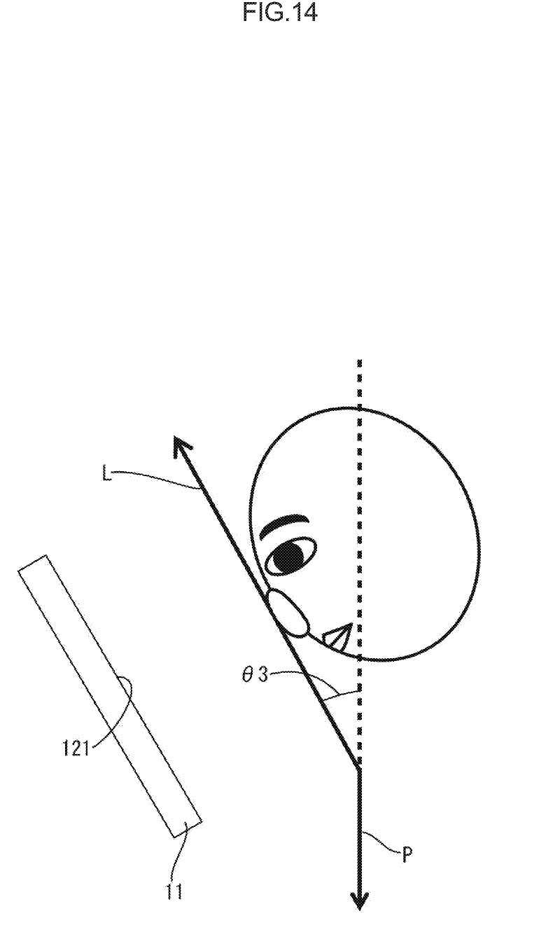

FIG. 13 is an explanatory view schematically indicating one example of the angle θ3 between the gravity direction P and the vertical direction L of the face of the user U viewed from the front. FIG. 14 is an explanatory view schematically indicating one example of the angle θ3 between the gravity direction P and the vertical direction L of the face of the user U viewed from the left, which is the same user as in FIG. 13. In FIG. 13 and FIG. 14, the inclination angle (θ3) of the user U is relatively small (i.e., the inclination angle (θ3) of the face of the user U is smaller than β). The inclination angle (θ3) of the face of the user U may be smaller than β when the user U in a standing or seated position uses the display device 11 while holding it in the hand, for example.

As illustrated in FIG. 13 and FIG. 14, the face inclination angle (the angle θ3) is determined by the vertical direction L of the face of the user U determined by the facial direction detector 164 and the gravity direction P. As illustrated in FIG. 14, in this embodiment, the vertical direction L of the face of the user U is parallel to the display surface 121 of the display device 1.

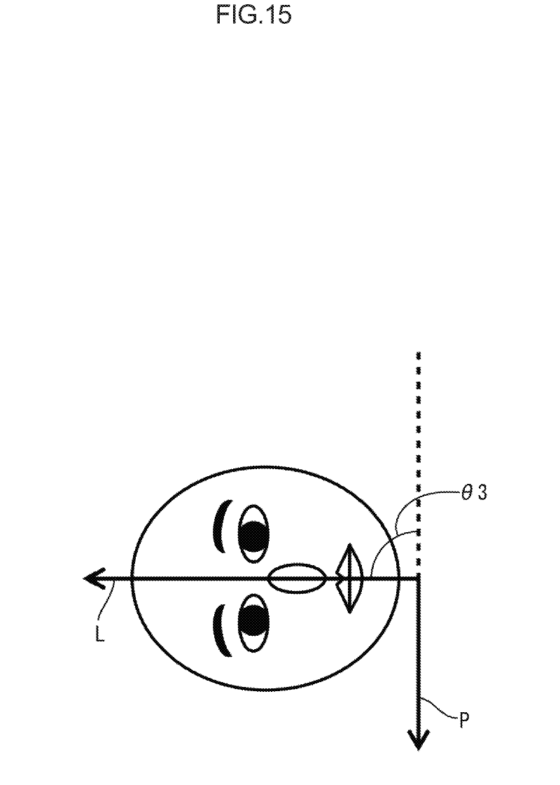

FIG. 15 is an explanatory view schematically indicating one example of θ3 between the gravity direction P and the vertical direction L of the face of the user U viewed from the front. In FIG. 15, the face inclination angle (angle θ3) of the user U is 90° (i.e., the face inclination angle (θ3) of the user U is β or larger). The face inclination angle (θ3) of the user may be β or larger when the user U lying sideways on the horizontal plane uses the display device 11 while holding it in the hand, for example.

The rotation corrector 169 replaces the “vertical direction L of the face of the user U”, which is stored in the memory 17 and used as a parameter by the image rotation data generator 165 for generation of the image rotation data, with the “vertical direction Q of the display surface 121 relative to the gravity direction P” when the face inclination angle detector 168 determines that the face inclination angle (θ3) is smaller than β.

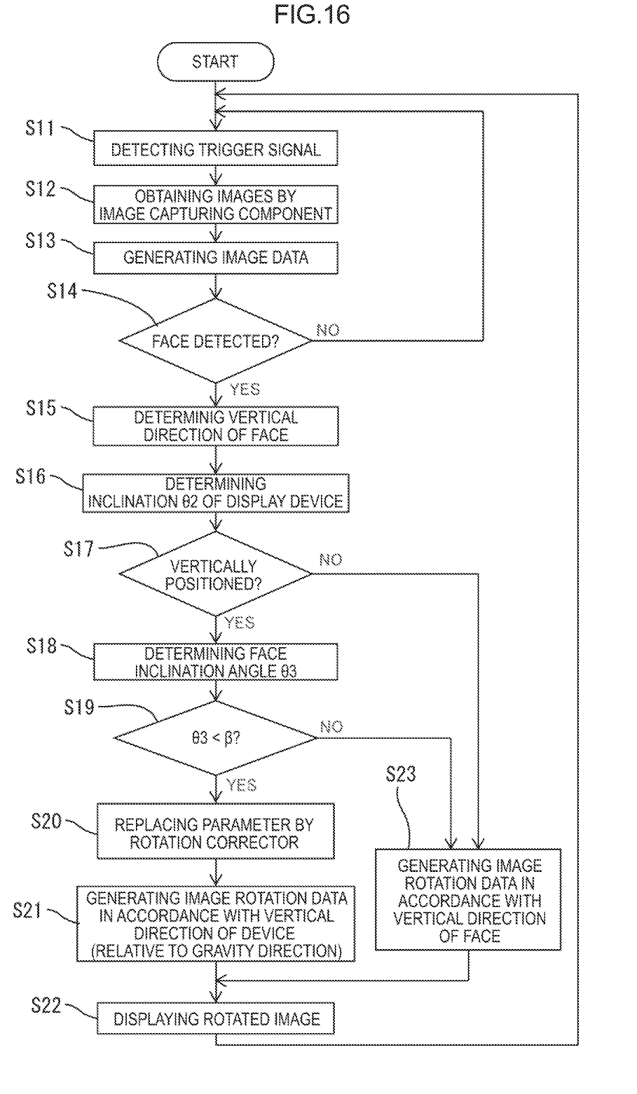

Next, the processing steps of the rotational display control according to the second embodiment will be described. FIG. 16 is a flowchart indicating the processing steps of the rotational display control according to the second embodiment.

First, at step S11, as step S1 in the above-described first embodiment, the trigger signal allowing the trigger detector 161 to start the rotational display control processing is detected.

After the detection of the trigger signal by the trigger detector 161, the process moves to step S12. At step S12, as step S2 in the first embodiment, the image capturing component 14 takes images based on instructions from the control component 16. The image capturing component 14 generates electrical signals (captured image data) relating to the captured image, and the electrical signals is input to the signal processor 162. Then, the process moves to step S13.

At step S13, after input of the electrical signals, the signal processor 162 converts the electrical signals to image data (captured image data) and temporally stores the image data in the memory 17. Then, the process moves to step S14.

At step S14, as step S4 in the above-described first embodiment, the face detector 163 retrieves the image data obtained by the image capturing component 14 and detects (finds) the face of the user U in the image data. Then, if the face detector 163 detects the face in the image data, the process moves to step S15. If the face detector 163 does not detect the face, the display device 11 waits until the next trigger signal is detected.

At step S15, as the above-described step S5, the vertical direction L of the face of the user U is detected. After the detection of the vertical direction L of the face of the user U, the process moves to step S16.

At step S16, the device orientation determiner 167 determines the orientation angle θ2 (0≦θ2(°)≦90) between the gravity direction P and the display surface 121 of the display device 11. At the same time, the vertical direction Q of the display surface 121 relative to the gravity direction P is also determined.

Then, the process moves to step S17 where the device orientation determiner 167 determines whether the orientation of the display device 11 is “vertical” or “horizontal” based on the orientation angle θ2.

At step S17, if the orientation of the display device 11 is determined to be vertical, the process moves to step S18. On the contrary, at step S17, if the orientation of the display device 11 is determined to be not vertical (i.e., horizontal), the process moves to step S23.

At step S18, the face inclination angle detector 168 determines the face inclination angle θ3, and then the process moves to step S19 where the face inclination angle detector 168 determines whether the face inclination angle θ3 is smaller than β (for example, 45°) or not. If the face inclination angle θ3 is smaller than β (θ3<β), the process moves to step S20. On the contrary, if the face inclination angle θ3 is β or larger (θ3≧β), the process moves to step S23.

At step S20, the rotation corrector 169 replaces the “vertical direction L of the face of the user U”, which is stored in the memory 17 and used as a parameter by the image rotation data generator 165 for generation of the image rotation data, with the “vertical direction Q of the display surface 121 relative to the gravity direction P”. Then, the process moves to step S21.

At step S21, the image rotation data generator 165 calculates the rotation angle of the image I based on the vertical direction Q of the display surface 121 relative to the gravity direction P and the preset coordinate system of the display surface 121, for example, and generates image rotation data (correction display image data) for rotating the image I by the calculated angle.

For example, the image rotation data generator 165 determines the vertical direction M of the image I immediately before the detection of the trigger signal at step S11 and calculates the angle θ11 (°) (0≦θ11(°)≦180) between the vertical direction M and the vertical direction Q of the display surface 121 relative to the gravity direction P. After the calculation of the angle θ11, the image rotation data generator 165 generates the image rotation data (correction display image data) for rotating the image I by the angle θ11.

Then, the process moves to step S22 where the display controller 166 allows the image I rotated by the angle θ11 from the state Immediately before the detection to be displayed on the display surface 21 of the display device 1 based on the image rotation data (correction display image data).

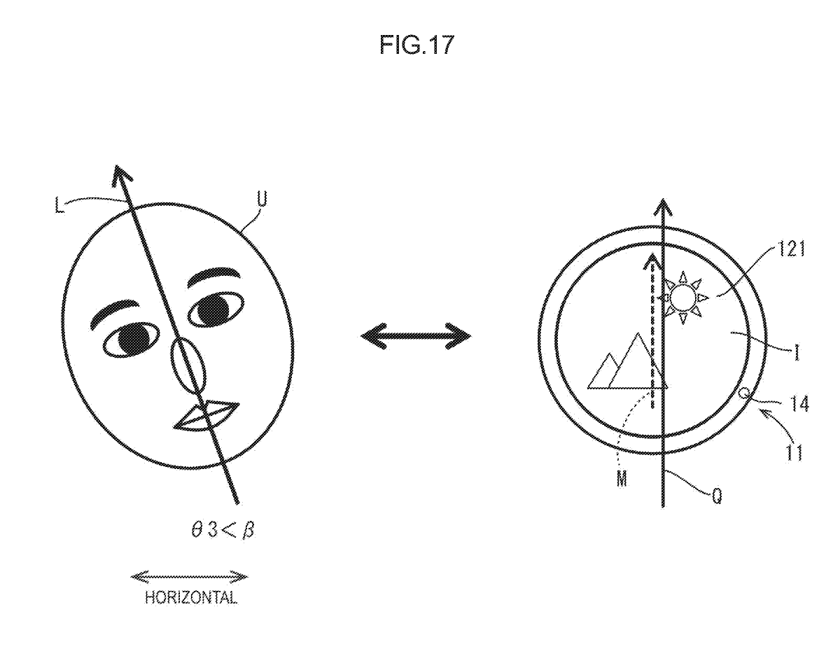

FIG. 17 is an explanatory view schematically illustrating the image I displayed on the display device 11 when the face inclination angle θ3 is smaller than β. As illustrated in FIG. 17, when θ3<β is satisfied, the image I is displayed on the display surface 121 of the display device 11 to align the vertical direction M of the image I with the vertical direction Q of the display surface 121 relative to the gravity direction P.

On the contrary, when the face inclination angle θ3 is β or larger (θ3≧β), the process moves to step S23 where the image rotation data generator 165 calculates the rotation angle of the image I based on the vertical direction L of the face and the preset coordinate system of the display surface 121, for example, and generates the image rotation data (display image data) for rotating the image I by the calculated angle, as step S6 in the first embodiment.

For example, the image rotation data generator 165 determines the vertical direction M of the image I immediately before the detection of the trigger signal at step S11 and calculates the angle θ12 (°) between the vertical direction M and the vertical direction L of the face (0≦θ12≦180). After the calculation of the angle θ12, the image rotation data generator 165 generates the image rotation data for rotating the image I by the angle θ12 to align the vertical direction M of the image I with the vertical direction L of the face of the user U.

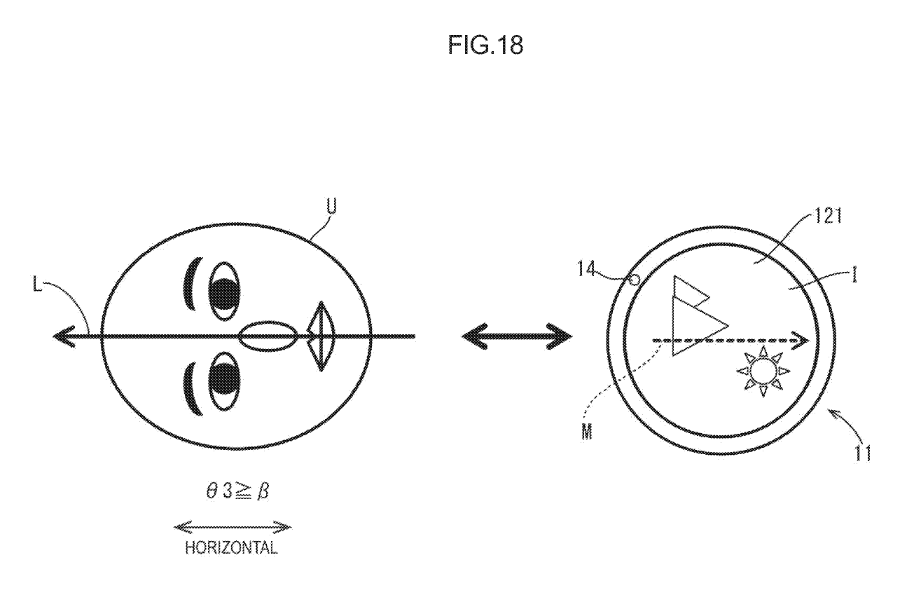

FIG. 18 is an explanatory view schematically illustrating the image I displayed on the display device 11 when the face inclination angle θ3 is β or larger. As illustrated in FIG. 18, if θ3≧β is satisfied, the image I is displayed on the display surface 121 of the display device 11 to align the up and direction M of the image I with the vertical direction L of the face of the user U, as the first embodiment.

At step S17, if the orientation of the display device 11 is determined to be not vertical (i.e., horizontal), the process moves to step S23 where the image rotation data generator 165 calculates the rotation angle θ13 of the image I based on the vertical direction L of the face and the preset coordinate system of the display device 11 (the display surface 21), for example, and generates image rotation data (the display image data) for rotating the image I by the calculated angle, as step S6 in the first embodiment.

Then, the process moves to step S22 where the display controller 166 displays the image I rotated by the angle θ13 from the state immediately before the detection on the display surface 21 of the display device 1 based on the rotational image date (display image data).

After step S22, the display device 11 waits until the next trigger signal is detected.

As described above, the display device 11 according to this embodiment changes the contents of the display control, through the above-described processing steps, depending on whether the orientation of the display device 11 is vertical or horizontal. When the horizontally positioned display device 11 is used, the display is controlled to align the vertical direction M of the image I with the vertical direction L of the face of the user U.

When the vertically positioned display device 11 is used, the face inclination angle θ3 with respect to the gravity direction P is small in some cases. In such cases, the image is made more readily viewable by matching the up and direction M of the image I to the vertical direction Q of the display surface 121 relative to the gravity direction P, than by matching the vertical direction M of the image I to the vertical direction L of the face of the user U.

Thus, in the display device 11 according to this embodiment, if the face inclination angle θ3 is small (for example, θ3<β) while the display device 11 is vertically positioned, the display is controlled to align the vertical direction M of the image I with the vertical direction Q of the display surface 121 relative to the gravity direction P.

When the display device 11 is vertically positioned, the face inclination angle θ3 is large (for example, θ3≧β) in some cases. In such cases, the display is controlled to align the vertical direction M of the image I matches the vertical direction L of the face of the user U.

### Third Embodiment

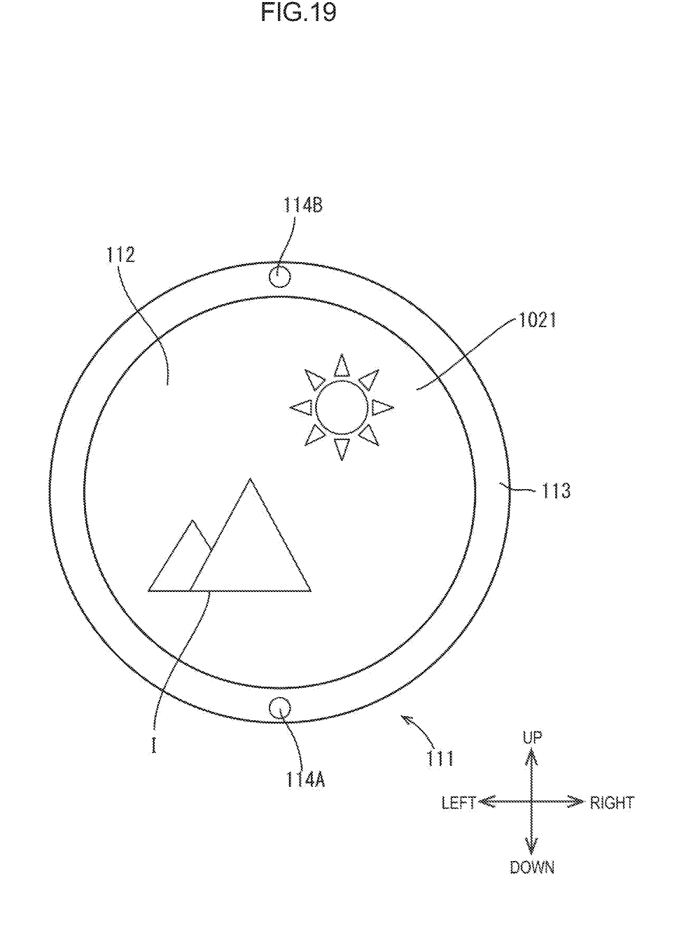

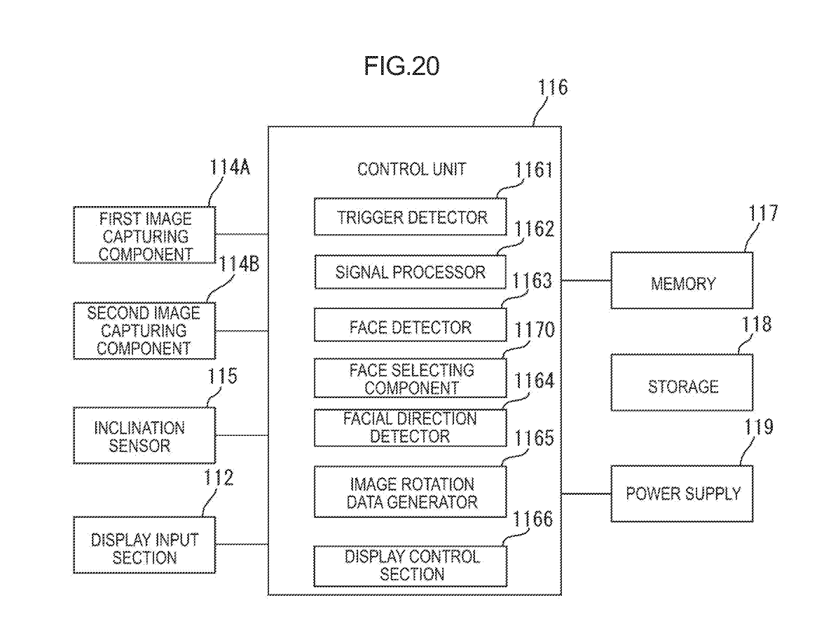

Next, a third embodiment of the invention is described with reference to FIG. 19 to FIG. 22. FIG. 19 is a front view of a display device 111 according to the third embodiment. FIG. 20 is a block diagram indicating a configuration example of the display device 111 according to the third embodiment.

The display device 111 includes two image capturing components 114A and 11B. The display device 111 includes a display input section 112, an inclination sensor 115, a control component 116, a memory 117, a storage 118, and a power supply 119, as the first embodiment.

The control component 116 includes a trigger detector 1161, a signal processor 1162, a face detector 1163, a facial direction detector 1164, an image rotation data generator 1165, and a display controller 1166, as the first embodiment.

The control component 116 of this embodiment further includes a face selecting portion 1170.

The face selecting portion 1170 is configured to determine, if multiple face information pieces are included in the image data obtained by the image capturing components 114A and 114B, one of the face information pieces closest to the display device 111 as the face of the user U.

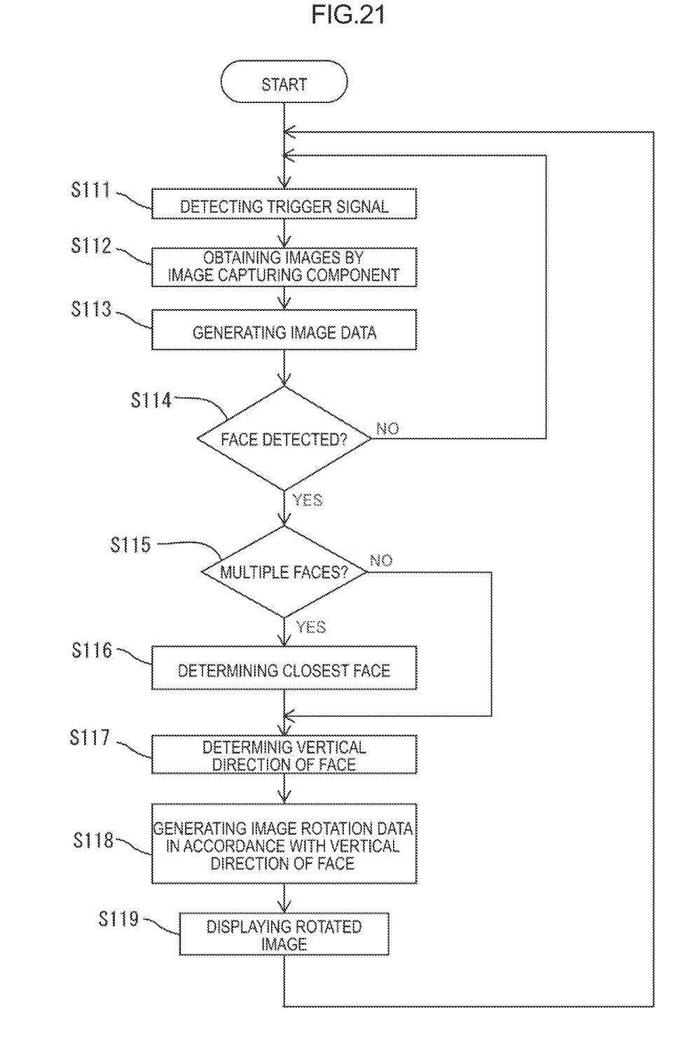

Next, the processing steps of the rotational display control according to the third embodiment will be described. FIG. 21 is a flowchart indicating the processing steps of the rotational display control according to the third embodiment.

First, at step S111, as step S1 in the above-described first embodiment, the trigger detector 1161 detects the trigger signal to start the rotational display control processing.

Next, the process moves to step S112 where the two image capturing components 114A and 114B take an image based on instructions from, the control component 116. The two image capturing components 114A and 114B each generate electrical signals (captured image data) relating to the captured image and the electrical signals (captured image data) are input to the signal processor 1162. Then, the process moves to step S113.

At step S113, after input of the electrical signals (the captured image data), the signal processor 1162 converts the electrical signals (the captured image data) into the image data (captured image data) DA and DB and temporally stores the image data DA and DB in the memory 117. Then, the process moves to step S114.

At step S114, as step S4 in the above-described first embodiment, the face detector 1163 retrieves the image data DA and DB obtained by the image capturing components 114A and 114B and detects (finds) the face of the user U in the image data DA and DB. If the face detector 1163 detects no face, the display device 111 waits until the next trigger signal is detected.

Next, at step S115, the face detector 1163 determines the number of faces. Specifically, the face detector 1163 determines if one face information piece has been detected or multiple face information pieces has been detected. When multiple faces nave been detected, the process moves to step S116. When only one face has been detected, the process moves to step S117,

When multiple faces are detected, at step S116, the face selecting portion 1170 selects one of the faces closest to the display device 111 as the face of the user U. In this embodiment, as an example case, the image data DA and DB obtained by the image capturing components 114A and 114B include two face information pieces relating to two persons U1 and U2.

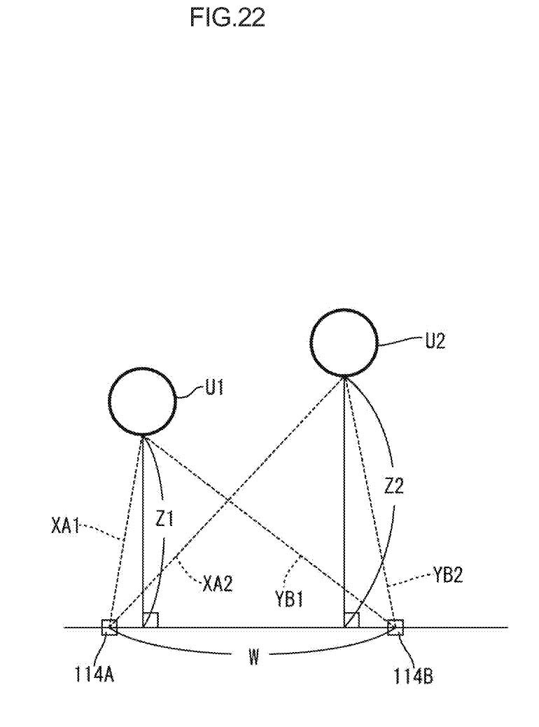

FIG. 22 is an explanatory view schematically illustrating a method of determining distances Z1 and Z2 between each of the persons U1 and U2 and the display device 111 based on the two face information pieces relating to the two persons U1 and U2.

The face selecting portion 1170 uses the image data DA and DB to determine the distances Z1 and Z2 between each of the persons U1 and U2 and the display device 111 by using a triangulation method.

The face selecting portion 1170 determines a distance XA1 between the image capturing component 114A and the person U1 and a distance XA2 between the image capturing component 114A and the person U2 based on the image data DA obtained by the image capturing component 114A.

Furthermore, the face selecting portion 1170 determines a distance YB1 between the image capturing component 114B and the person U2 and a distance YB2 between the image capturing component 114B and the person U2 based on the image data DB obtained by the image capturing component 114B.

A distance W between the image capturing component 114A and the image capturing component 114B is a predetermined value.

The face selecting portion 1170 calculates the distance Z1 between the person U1 and the display device 111 based on the values of the distance XA1, the distance YB1, and the distance W. The face selecting portion 1170 also calculates the distance Z2 between the person U2 and the display device 111 by using the values of the distance XA2, the distance YB2, and the distance W.

Then, as described above, the face selecting portion 1170 compares the distance Z1 between the face of the person U1 and the display device 111 and the distance Z2 between the face of the person U2 and the display device 111, and selects the user U1 located at a shorter distance from the display device 111, as the user U. After the identification of the face information about the face of the user U at step S116, the process moves to step

At step S117, as step S5 in the above-described first embodiment, the vertical direction L of the face of the user U is determined. After the determination of the vertical direction L of the face of the user U, the process moves to step S118.

At step S118, as step S6 in the above-described first embodiment, the image rotation data generator 1165 calculates a rotation angle of the image I based on the vertical direction L of the face and the preset coordinate system of the display device 111 (the display surface 1121), for example, and generates an image rotation data for rotating the image I by the calculated angle.

Then, the process moves to step S119 where the display controller 1166 displays the image on the display surface 21 of the display device 1 based on the image rotation data as step S7 in the above-described first embodiment.

After step S119, the display device 111 waits until the next trigger signal is detected.

As described above, in the display deice 111 according to this embodiment, through the above-described processing steps, the multiple image capturing components 114A and 114B take multiple image data DA and DB, and the face selecting portion 1170 uses the image data DA and DB to select one of the face information pieces closest to the display device 111 from the image data DA and DB as the face information about the face of the user U. With this configuration, the display device 111 according to this embodiment distinguishes the user U from the other people when performing the control of the image I displayed on the display surface 1121.

### Fourth Embodiment

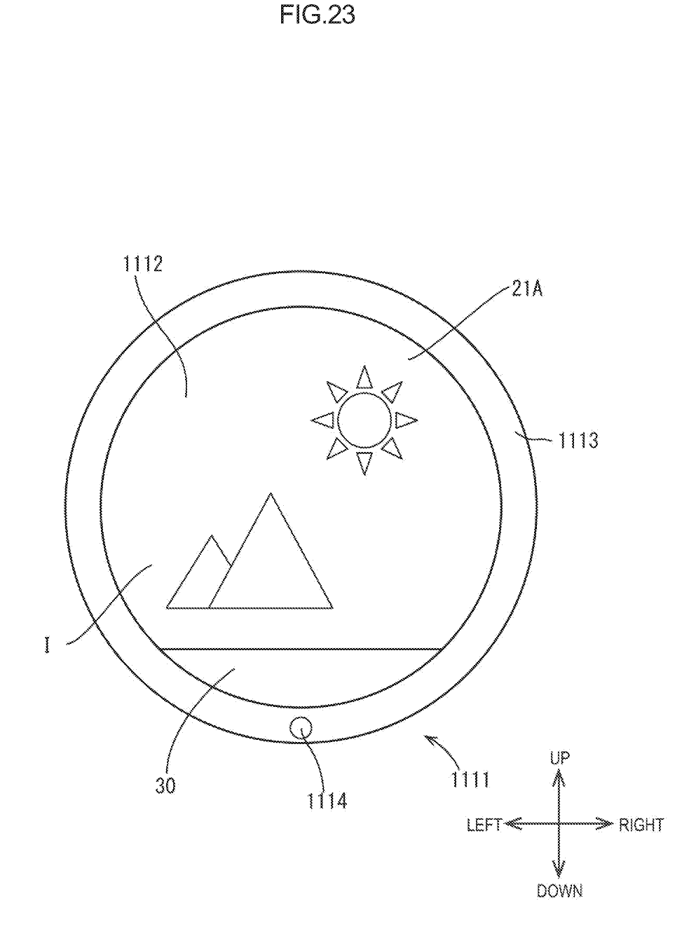

Next, a fourth embodiment of the invention is described with reference; to FIG. 23. FIG. 23 is a front view of a display device 1111 according to the third embodiment.

In the display device 1111, a display input section (a display component) 1112 (i.e., the display surface 21A), which is exposed to the front side, does not a true circular shape and has a circular shape with a cutout. A cover 30 covers the cutout. In other words, the display surface 21A and the cover 30 having light-blocking properties form one circle. In addition, a frame 1113 surrounds the display surface 21A and the cover 30, which form the circular shape.

The display device 1111 has the basic configuration and function similar to those in the first embodiment and performs the display control (the rotational display control) of the image I, which is to be displayed on the display surface 21A, based on the image (captured image data) obtained by the image capturing component 1114, as in the first embodiment.

As described above, the display surface 21A of the display device 1111 may have a substantially circular shape.

### Other Embodiments

The present invention is not limited to the embodiments described above and illustrated by the drawings. For example, the following embodiments will be included in the technical scope of the present invention.

(1) The display devices in the above-described embodiments each have a circular or substantially circular display surface, but may have a polygonal display surface or any other shaped display surface, without failing to achieve the object of the invention. However, the display surface preferably has the circular or substantially circular shape as in the above-described embodiments, because the display device having the circular or substantially circular display surface will be positioned in various orientations (device orientations).

(2) In the above-described embodiments, the liquid crystal display panel is used as the display component (the display input section), but the present invention is not limited thereto. A display component using another display system may be used.

(2) The display devices in the above-described embodiments may further include a communication processing unit for wireless communication or wire communication through a wireless network or a wired network. In the display device, the image based on the image data received by using the communication processing unit may be displayed on the display surface of the a display component.

(3) In the above-described embodiments, eyes and a nose are used as reference points to detect the face of the user in the image data (the captured image data). However, the face information may be detected based on other information (for example, sunglasses, eyeglasses, a mask, an eyebrow, a nose, a facial contour such as a jaw), which allows detection of the face information, as a reference point.

(4) In the above-described third embodiment, two image capturing components are used and one of multiple face information pieces closest to the display device (the display surface) is selected. However, without failing to achieve the object of the present invention, the face information may be selected from the captured image data obtained by one image capturing component, for example, or the face information may be selected from three or more captured image data pieces obtained by three or more image capturing components.

(5) In the above-described embodiments, the rotational display control processing starts (the image capturing component 4 starts taking images) upon detection of the predetermined trigger signal. However, the rotational display control may be intermittently performed at a predetermined time interval, for example;.

(6) The display devices in the above-described embodiments may further include a sensor such as an angular velocity sensor (a gyroscope), for example. The output from the sensor may be used as a trigger signal to start the rotational display control processing (the image capturing component 4 starts taking images).

(7) The display devices in the above-described embodiments each have a circular outer shape (exterior shape) in plan view, but the present invention is not limited thereto. For example, the display device may have a protrusion extending from a circular outer edge or may have a polygonal shape.

### EXPLANATION OF SYMBOLS

1 display device
2 display component (display input section)
21 display surface
3 frame
4 image capturing component
5 inclination sensor
6 control component
61 trigger detector
62 signal processor
63 face detector
64 facial direction detector
65 image rotation data generator
6 6 display controller
7 memory
8 storage
9 power supply
U user
L vertical direction of face
I image
M vertical direction of image
P gravity direction
Q vertical direction of display surface relative to the gravity direction (inclination angle of display surface)

1. A display device comprising:
a display component having a display surface on which an image is displayed;
at least one image capturing component configured to obtain captured image data; and
a control component configured to detect face information about a face of a user in the captured image data, determine a vertical direction of the face based on the face information, generate display image data for rotating the image to align a vertical direction of the image with the vertical direction of the face, and display the image on the display surface based on the display image data.

2. The display device according to claim 1, further comprising an inclination sensor configured to detect an orientation angle between an inclination direction of the display surface and a gravity direction,
wherein the control component is configured to determine a device orientation by the orientation angle, which is formed between the inclination direction and the gravity direction, and generate the display image data in accordance with a result of determination of the device orientation.

3. The display device according to claim 2, wherein the control component is configured to determine that the device orientation is horizontal when the orientation angle is relatively large and determine that the device orientation is vertical when the orientation angle is relatively small.

4. The display device according to claim 3, wherein when the device orientation is determined horizontal, the control component generates the display image data.

5. The display device according to claim 3, wherein when the device orientation is determined vertical, the control component calculates a face inclination angle between the gravity direction and the vertical direction of the face and generates the display image data in accordance with the face inclination angle.

6. The display device according to claim 5, wherein when the face inclination angle is relatively small, the control component replaces the vertical direction of the face with the vertical direction of the display surface relative to the gravity direction and generate correction display image data, instead of the display image data, for rotating the image to align the vertical direction of the image with the vertical direction of the display surface,

7. The display device according to claim 5, wherein when the face inclination angle is relatively large, the control component generates the display image data for rotating the image to align the vertical direction of the image with the vertical direction of the face.

8. The display device according to claim 1, wherein, when multiple face information pieces are detected in the captured image data, the control component selects one of the multiple face information pieces closest to the display surface as the face information about the face of the user and determine the vertical direction of the face based on the selected face information piece.

9. The display device according to claim 8, wherein
the at least one image capturing component includes a plurality of image capturing components, the plurality of image capturing components being configured to obtain pieces of captured image data relating to the user, and
the control component is configured to select one of multiple face information pieces closest to the display surface as the face information about the face of the user from the pieces of captured image data.

10. The display device according to claim 1, wherein the display surface has a circular or substantially circular shape.

11. The display device according to claim 1, wherein the control component is configured to detect a trigger signal allowing the at least one image capturing component to start obtaining captured image data.

12. The display device according to claim 11, wherein the trigger signal is an output from the inclination sensor configured to determine the orientation angle between the display surface and the gravity direction.

13. The display device according to claim 11, further comprising an input section configured to receive information from the user and output the received information to the control component, the trigger signal being an output from the input section,

14. A method of displaying an image on a display device including a display component having a display surface on which an image is displayed, at least one image capturing component, and a control component, the method comprising:
obtaining captured image data by the at least one image capturing component;
detecting face information about a face of a user in the captured image data by the control component;
determining an vertical direction of the face of the user by the control component based on the face information;
generating a display image data for rotating the image, by the control component, to align the vertical direction of the image with the vertical direction of the face; and
displaying the image on the display surface of the display component by the control component based on the display image data.

15. The method of displaying an image on the display device according to claim 14, wherein the display surface has a circular or substantially circular shape.
